(19) United States
(12) Patent Application Publication
(10) Pub. No.: US 2011/0016525 A1
(43) Pub. Date: Jan. 20, 2011

(54) APPARATUS AND METHOD FOR DETECTING NETWORK ATTACK BASED ON VISUAL DATA ANALYSIS

(76) Inventors: Chi Yoon Jeong, Daejeon (KR); Beom-Hwan Chang, Daejeon (KR); Seon-Gyoung Sohn, Daejeon (KR); Johg Ho Ryu, Daejeon (KR); Geon Lyang Kim, Daejeon (KR); Jonghyun Kim, Daejeon (KR); Jung-Chan Na, Daejeon (KR); Hyun sook Cho, Daejeon (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/630,672

(22) Filed: Dec. 3, 2009

(30) Foreign Application Priority Data
Jul. 14, 2009 (KR) 10-2009-0069418

(51) Int. Cl. G06F 21/00; G06K 9/68

(52) U.S. Cl. 726/23; 382/218

(57) ABSTRACT

An apparatus for detecting a network attack includes a traffic image generator for generating a traffic image using traffic information and additional IP information extracted from the traffic information; a network attack detector for comparing similarities between the traffic image and a previously generated traffic image based on a predetermined similarity threshold to detect the presence of the network attack; and a network attack analyzer for analyzing the traffic image at a time when the network attack is detected to detect network attack information and pattern information of the network attack. A representation unit for visualizing the network attack information and the pattern information of the network attack.

### CROSS-REFERENCE(S) TO RELATED APPLICATION(S)

The present invention claims priority of Korean Patent Applications No. 10-2009-0069418, filed on Jul. 14, 2009, which is incorporated herein by reference.

### FIELD OF THE INVENTION

The present invention relates to an apparatus and method for detecting network attack based on visual data analysis, and more particularly, to an apparatus and method wherein traffic information is transformed into traffic images and various attack data occurring in a network is detected from the traffic images using a visual data analysis technique.

### BACKGROUND OF THE INVENTION

Generally, two intrusion detection models, such as an abnormal detection model and a misuse detection model, have been used in order to detect attack data occurring in a network. The abnormal detection model models the property of the normal behavior of network traffic, and then, decides the modeled property different from that of a normal behavior model as a network attack. The misuse detection model generates a signature for a prior attack and checks whether or not the signature exists in network traffic at current to detect network attack.

These detection models have been applied properly to those where network establishment is required, but have defects in coping with intrusions as it is under the current circumstance where the types of intrusion are being diversified.

As mentioned above, the conventional detection models have many problems in applying them to the network, some important problems of which will be given below.

For the abnormal detection model, it has a great difficulty in creating a sophisticated normal behavior model because it depends on network properties and, among other things, makes many misjudgments of deciding non-attacks as attacks.

Further, the misuse detection model enables precise detection for known attacks, but does not make detection for unknown attacks. Especially, with increase in the type of attacks, the misuse detection model has a bulky database storing signatures.

### SUMMARY OF THE INVENTION

The present invention provides an apparatus and method for detecting network attack based on visual data analysis wherein traffic information is transformed into traffic images and various attack data occurring in a network is detected from the traffic images using a visual data analysis technique.

In accordance with the present invention, there is provided an apparatus for detecting a network attack, including:

a traffic image generator for generating a traffic image using traffic information and additional IP information extracted from the traffic information;

a network attack detector for comparing similarities between the traffic image and a previously generated traffic image based on a predetermined similarity threshold to detect the presence of the network attack;

a network attack analyzer for analyzing the traffic image at a time when the network attack is detected to detect network attack information and pattern information of the network attack; and

a representation unit for visualizing the network attack information and the pattern information of the network attack.

In accordance with the present invention, there is provided a method for detecting a network attack, including:

generating a traffic image using traffic information and additional IP information extracted from the traffic information;

comparing similarities between the traffic image and a previously generated traffic image based on a predetermined similarity threshold to detect the presence of the network attack;

analyzing the traffic image to detect network attack information and pattern information of the network attack; and

visualizing the network attack information and the pattern information of the network attack.

### BRIEF DESCRIPTION OF THE DRAWINGS

The above and other objects and features of the present invention will become apparent from the following description of preferred embodiments, given in conjunction with the accompanying drawings, in which:

FIG. 1 shows a block diagram of an apparatus for detecting network attack based on visual data analysis in accordance with an embodiment of the present invention;

FIG. 2 illustrates a detailed block diagram of the traffic image generator shown in FIG. 1;

FIG. 3 provides a detailed block diagram of the network attack detector shown in FIG. 1;

FIG. 4 illustrates a detailed block diagram of the network attack analyzer shown in FIG. 1;

FIG. 5 depicts a detailed block diagram of the network attack detection result display unit shown in FIG. 1;

FIG. 6A is a traffic image plotted using source IP and destination information in accordance with one embodiment of the present invention;

FIG. 6B is a graph of the traffic frequency at y-axis with respect to the destination port number at x axis in accordance with an embodiment of the present invention;

FIG. 6C is a traffic image showing distributed denial of service attack in traffic by mapping the source IP and destination IP to IP addresses in accordance with an embodiment of the present invention;

FIG. 6D is a traffic image showing internet warm in traffic by mapping the source IP and destination IP to IP addresses in accordance with an embodiment of the present invention;

FIG. 7 is a view for deciding presence or absence of network attack based on the similarity comparison between a traffic image and a previously inputted traffic image by the attack detector in accordance with an embodiment of the present invention;

FIG. 8A is a view showing that two uniform regions and one spot region are detected for an image for host analysis, in accordance with an embodiment of the present invention;

FIG. 8B is a view showing that three uniform regions and one spot region are detected for an image for port analysis, in accordance with an embodiment of the present invention;

FIGS. 9A to 9F illustrate maps showing detected attacks in accordance with an embodiment of the present invention; and

FIGS. 10A, 10B and 10C illustrate flow charts sequentially showing a method for detecting network attack based on visual data analysis in accordance with an embodiment of the present invention.

### DETAILED DESCRIPTION OF THE EMBODIMENTS

Hereinafter, the operational principle of the present invention will be described in detail with reference to the accompanying drawings. In the following description, well-known functions or constitutions will not be described in detail if they would obscure the invention in unnecessary detail. Further, the terminologies to be described below are defined in consideration of functions in the present invention and may vary depending on a user's or operator's intention or practice. Therefore, the definitions should be understood based on all the contents of the specification.

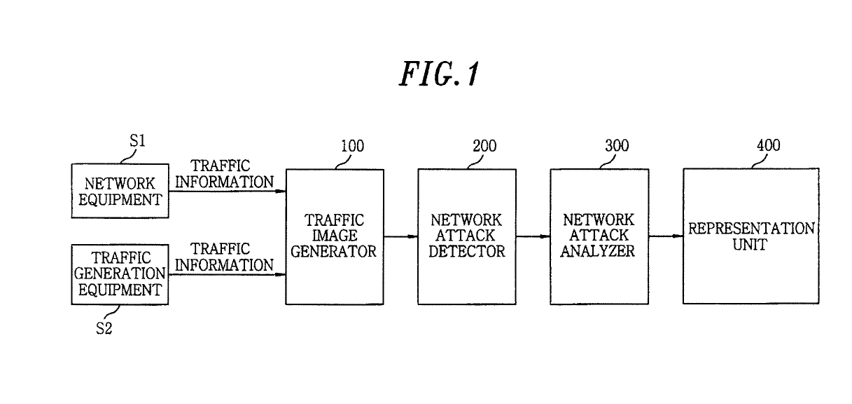

FIG. 1 shows a block diagram of an apparatus for detecting network attack based on visual data analysis in accordance with an embodiment of the present invention. As shown, the apparatus includes a traffic image generator 100, a network attack detector 200, a network attack analyzer 300, and a representation unit 400.

The traffic image generator 100 collects traffic information and transforms the traffic information into a traffic image based on additional IP information. The network attack detector 200 compares similarities between the traffic image and a previous traffic image based on a predetermined similarity threshold to detect a network attack. The network attack analyzer 300 analyzes the traffic image at a time when the network attack is detected to identify network attack information and pattern information of the network attack. And, the representation unit 400 displays the network attack information and the pattern information of the network attack on a screen.

Referring to FIG. 2, there is shown a detailed block diagram of the traffic image generator 100 shown in FIG. 1.

The traffic image generator 100 includes a traffic information collector 101, an internet protocol (IP) address extractor 103, an IP information database (DB) 105, and a traffic image generator 107. The IP information DB 105 stores, in DB or file format, source IPs and destination IPs, source ports, destination ports, protocols, statistics, and additional information such as country, autonomous system (AS), company, internet service provider (ISP), latitude, longitude, management domain, and the like to which an IP address contained in a source IP or an destination IP belongs, which are collected from all over the world.

The traffic information collector 101 collects traffic information (e.g., using Netflow or sflow standards for network monitoring to capture traffic information) received from a network equipment S1 (e.g., a router, etc.) or a traffic generation equipment S2 through network communications (e.g., communications using the transmission control protocol (TCP) or user datagram protocol (UDP)). The collected traffic information is normalized and the normalized traffic information is then provided to the IP address extractor 103 and the traffic image generator 107.

The IP address extractor 103 searches the IP information DB 105 for additional IP information of the normalized traffic information, such as source IP and destination IP, source port, destination port, protocol, statistic, and so on. Further, the IP address extractor 103 extracts geographical information including country, AS, company, ISP, latitude, longitude, and management domain to which the IP address belongs. The IP address extractor 103 then provides the source IP, destination IP, statistic and the additional IP information to the image generator 107.

The image generator 107 generates N×N traffic image using the additional IP information from the IP address extractor 103 and the normalized traffic information from the traffic information collector 101 in synchronized with a cycle T during which the traffic information is collected.

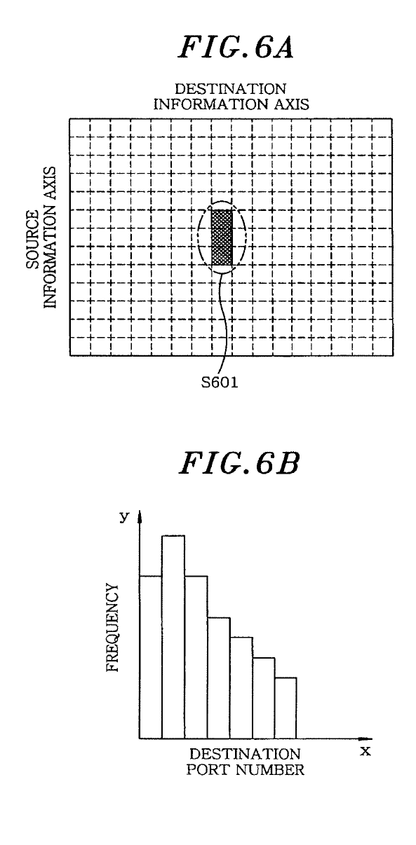

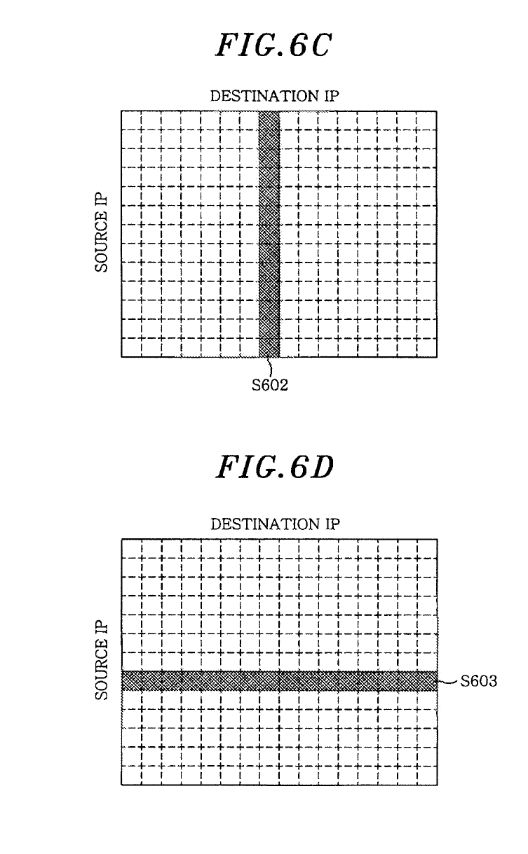

For example, FIG. 6A is a traffic image plotted using source IP and destination IP in accordance with one embodiment of the present invention.

The traffic image of N×N pixel is plotted with vertical and horizontal axes having destination and source information. The source information includes the source IP and the additional IP information having the country, AS, company, ISP, latitude, longitude, and management domain to which an IP address of the source IP belongs. In similar, the destination information includes the destination IP and the additional IP information having the country, AS, company, ISP, latitude, longitude, and management domain to which an IP address of the destination IP belongs. In shown in FIG. 6A, any pixel in the traffic image indicates traffic flowing to a destination from a source. Further, a color of the pixel in the traffic image is represented by statistic information extracted from the traffic information between the destination and the source. The N×N traffic image is then provided to the network attack detector 200.

FIG. 6A is a traffic image plotted using source IP and destination IP in accordance with the present invention, and FIG. 6B is a graph of the traffic frequency at y-axis with respect to the destination port number at x axis in accordance with the present invention.

For example, if the source IP and destination IP are used to plot the horizontal and vertical axes, respectively, the IP address is composed of 32 bits, resulting in a very wide range of traffic image. Therefore, it is necessary to abbreviate the wide range of the traffic image. For another example, if the country information of the IP address is used to plot the horizontal and vertical axes, the horizontal and vertical axes become 260, which is the maximal country number, to generate a 260×260 traffic image. In this case, a value of any pixel (x,y) S601 in the traffic image in FIG. 6A indicates traffic flowing to a destination country x from a source country y. Further, a color of the pixel (x,y) S601 in the traffic image in FIG. 6A may use various color spaces such as RGB, YCrCb, HSV (hue, saturation, and value), and the value of the pixel color indicates statistic information of the traffic flowing to the destination country x from the source country y. The statistic information is calculated the traffic information of the corresponding pixel. For another example, if a statistic value for a destination port is used, a traffic frequency at y axis corresponding to a destination port number at x axis is calculated, and then mean and variation of the destination port number are calculated, followed by mapping H to the mean, S to the variance, and V to the frequency of traffic, e.g., in HSV color space, to thereby represent them in a graph form as shown in FIG. 6B. In this case, pixel color represents a numerously-distributed port in traffics. It can be seen from the graph that high chroma indicates that scanning attack is being made, and increased black indicates that much traffic has occurred.

Alternatively, only the frequency of traffic is normalized to the value of 0 to 255 for a black-and-white image, thereby detecting network attack based on the black-and-white image.

FIGS. 6C and 6D show a traffic image plotted by using the source and destination IP addresses in accordance with an embodiment of the present invention.

In FIG. 6C, traffic is plotted by mapping an IP address to the source information and the destination information. As can be seen from FIG. 6C, the generation of the traffic from multiple source IPs to one destination IP indicates that DDoS attack S602 is being progressed. Meanwhile, FIG. 6D also represents a traffic image plotted by mapping an IP address to the source information and the destination information. In FIG. 6D, the generation of traffic from one source IP to multiple destination IPs indicates that internet warm S603 is occurring.

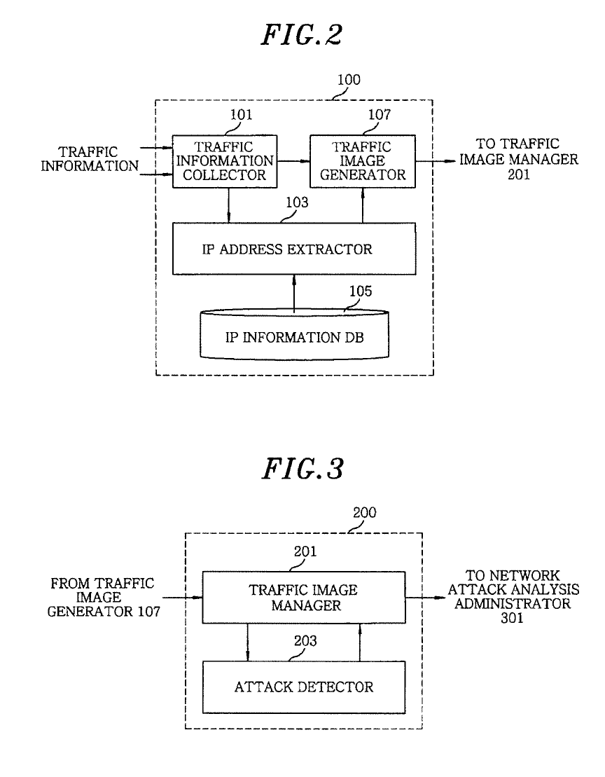

FIG. 3 illustrates a detailed block diagram of the network attack detector 200 shown in FIG. 1.

The network attack detector 200 includes the traffic image manager 201 and the attack detector 203.

The traffic image manager 201 stores the traffic image provided from the traffic image generation unit 100 for each cycle T. In response to a request from the attack detector 203, the traffic images stored in the traffic image manager 201 is transmitted to the attack detector 203.

The attack detector 203 compares similarities between a traffic image for each cycle T and a previously generated traffic image. If the similarity difference exceeds a similarity threshold, the attack detector 203 detects that there exists a network attack, and provides a detection result to the network attack analyzer 300 through the traffic image manager 201. It is preferred that the similarity comparison is performed by a scene change detection technique using the change in pixel color or between discrete cosine transform (DCT) variables.

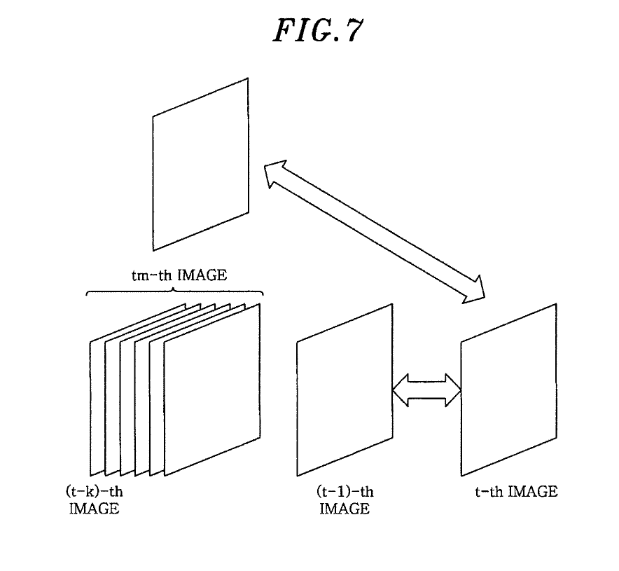

For example, as shown in FIG. 7, assuming that a t-th image is a traffic image at current time t, the attack detector 203 compares color and distribution information of the t-th image with those of (t−1)-th image generated at time t−1 and an averaged image tm of (t−2)-th to (t−k)-th images generated at time t−2 and t−k. If the color and distribution information exceeds the similarity threshold, the attack detector 203 decides the presence of network attack because large difference of color and distribution between the t-th image and the (t−1)-th image or tm image indicates the occurrence of any unintentional traffic that was not in a previous network traffic or any variation in traffic pattern.

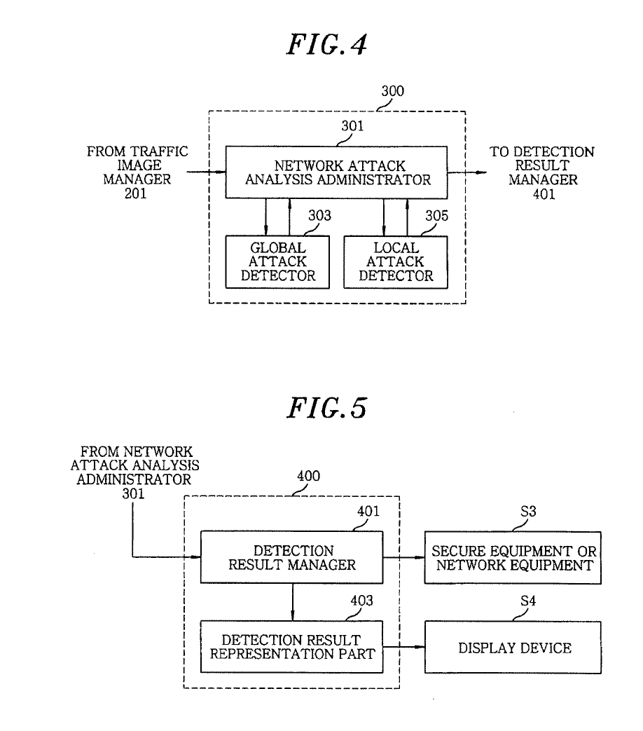

FIG. 4 illustrates a detailed block diagram of the network attack analyzer 300 shown in FIG. 1.

The network attack analyzer 300 includes a network attack analysis administrator 301, a global attack detector 303, and a local attack detector 305.

The network attack analysis administrator 301 decides that there is a global attack or a local attack depending on the detection result from the network attack detector 200, and provides the global attack detector 303 and the local attack detector 305 with the detection result from the network attack detector 200 to make a request for network attack analysis. Further, the network attack analysis administrator 301 generates network attack information and pattern information of the network attack based on an analysis result received from the global attack detector 303 and the local attack detector 305 in response to the request of the network attack analysis. The network attack information and pattern information of the network attack are then provided to the network attack detection result representation unit 400.

The global attack detector 303 serves to analyze a large-scale network to detect a kind of a global attack. The global attack refers to, e.g., a large-scale network attack which is the DDos attack, Internet warm attack, and so on. For the global attack, the global attack detector 303 detects a line in the traffic image using a line detection algorithm and decides whether the detected line is a horizontal line or a vertical line depending on the slope of the detected line. If the detected line is the horizontal line, which means that the traffic is being sent from a specific source IP to multiple destination IPs, the global attack detector 303 analyzes the traffic on the basis of the source IP to identify a kind of network attack. On the other hand, if the detected line is the vertical line, which means that the traffic is being sent from multiple source IPs to a specific destination IP, the global attack detector 303 analyzes the traffic on the basis of the destination IP to identify a kind of the network attack. Meanwhile, if the decision result indicates neither of the vertical line or the horizontal line, the global attack detector 303 analyzes the network attack based on the distribution of the source and destination IPs. The analysis result by the global attack detector 303 is then provided to the network attack analysis administrator 301.

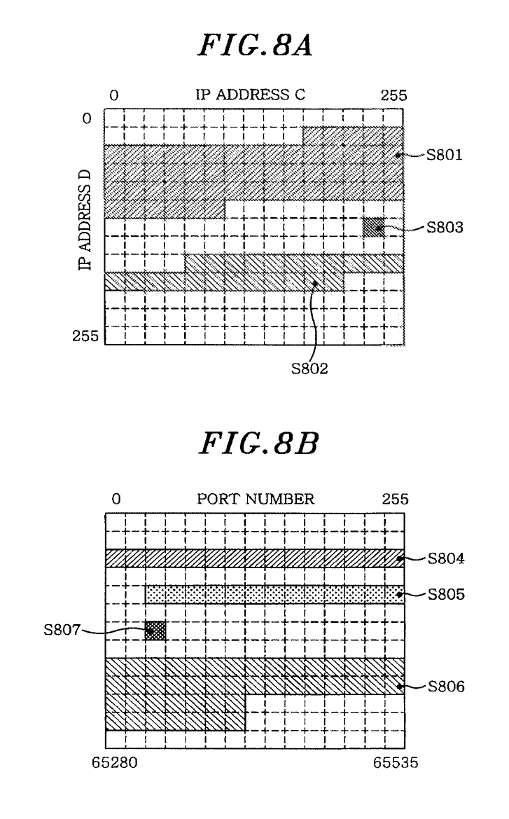

The local attack detector 305 serves to analyze a small-scale network to detect a kind of a local attack. The local attack refers to, e.g., the denial-of-service (DDos) attack and the other attack such as host scan, port scan, and so on. For the local attack, the local attack detector 305 selects a specific region in the traffic image. The selection of the specific region may be made by considering the traffic volume between the source and the destination, the distribution of source and destination ports existing in the corresponding traffic, and the distribution of the source and destination IP addresses. The local attack detector 305 then generates an image for destination host analysis and an image for port analysis with respect to the selected specific region to detect a uniform region and a spot region, as shown in FIGS. 8A and 8B. In addition, the local attack detector 305 analyzes the traffic image using an image processing technique such as an image segmentation technique, a connected component labeling technique or an edge detection technique to detect host and port with a specific feature. Thereafter, the local attack detector 305 checks traffic related to the host and port based on the detected uniform region and the spot region to identify a kind of the network attack. The analysis result by the local attack detector 305 is then provided to the network attack analysis administrator 301 where the network attack information indicating the kind of the network attack and the pattern information for the traffic image of the network attack are generated.

For example, in case where the range of the specific region in the detection of the local attack is set as B class, the local attack detector 305 analyzes the network attack based on traffics generated between B class networks.

Firstly, as shown in FIG. 8A, a host analysis image is represented by mapping transmission/reception traffic to the destination port number for each host. In the host analysis image, the horizontal axis indicates an IP address C of IP addresses A, B, C and D, and the vertical axis indicates an IP address D of the IP addresses. The host analysis image is processed by one of the image segmentation technique, the connected component labeling technique, and the edge detection technique to detect two uniform regions S801 and S802 in which the hosts have the same destination port and one spot region S803 in which the host has much traffic, thereby finding out a source IP or a destination IP for the uniform regions to acquire attacker or injurer. Alternatively, the frequency of traffic, rather than the destination port number, may be used in mapping the transmission/reception traffics for each host. Here, the uniform regions can be decided to be a host scanning attack which scans various hosts using the same destination port, and the spot region can be decided to be a port scanning attack or a denial of service attack which causes much traffic for the specific host.

Secondly, as shown in FIG. 8B, a port analysis image is represented by mapping the traffic volume generated for each source port or for each destination port with a value of 0 to 65535 to colors. The port analysis image is processed by one of the image segmentation technique, the connected component labeling technique, and the edge detection technique to detect three uniform regions S804, S805 and S806 in which ports in the regions have the distribution with the same traffic volume and one spot region S807 in which a port has concentrated traffic, followed by analyzing traffics of the detected regions to decide network attacks. In this case, the uniform regions can be decided to be a port scanning attack in which the ports have the same traffic volume; and the spot region has much traffic using the port and can be decided to be a denial of service attack or a host scanning attack depending on the distribution of source and destination IPs.

On the other hand, the representation unit 400 represents the detection information of the attack and original traffic flow of the attack as well as attack patterns of the traffic image, the host analysis image, and the port analysis image, so that a user or a network manager can intuitively understand and decide the phenomenon of the network.

FIG. 5 depicts a detailed block diagram of the representation unit shown in FIG. 1. As shown in FIG. 5, the representation unit 400 includes a detection result manager 401 and a detection result representation part 403.

The detection result manager 401 provides the detection result representation part 403 with the network attack information and pattern information of the network attacks from the network attack analyzer 300. The detection result manager 401 also generates and transmits an alarm message notifying that the network attack has occurred to other secure equipment or other network equipment S3 upon a manager's request or system setting, while managing the network attack information and the pattern information of network attack.

The result representation part 403 discriminately constructs a map for the network attack information and the pattern information of the network attack received from the detection result manager 401, to thereby represent the attack map on a display device S4.

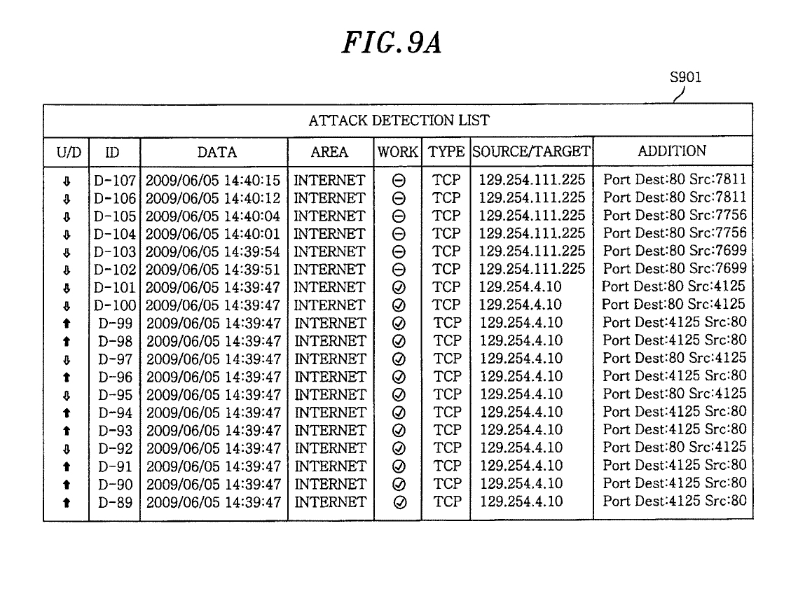

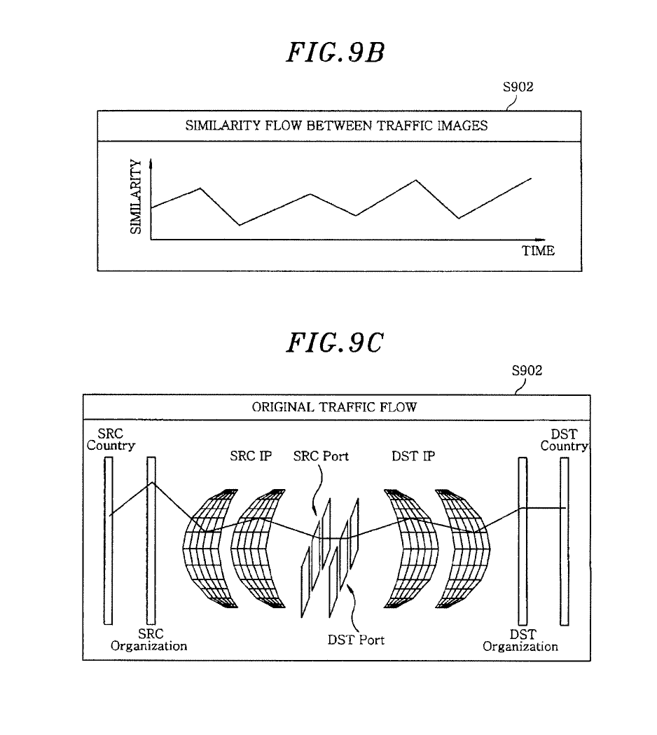

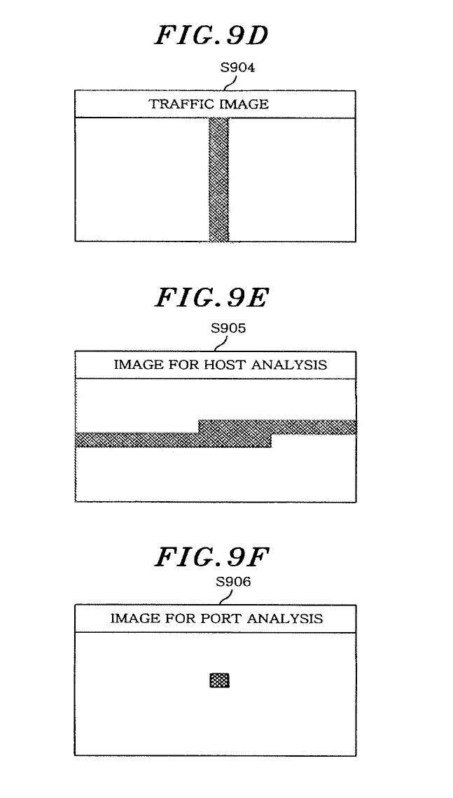

For example, FIGS. 9A to 9F illustrate maps showing detected attacks in accordance with an embodiment of the present invention. The maps include a network attack detection list S901 shown in FIG. 9A, a similarity between traffic images with the passage of time S902 shown in FIG. 9B, an original traffic flow S903 shown in FIG. 9C, a traffic image S904 shown in FIG. 9D, a host analysis image S905 shown in FIG. 9E and a port analysis image S906 shown in FIG. 9F. In particular, FIG. 9C shows a continued traffic flow from a source country to a destination country in which information on a source country (SRC Country), a source ISP (SRC Organization), a source IP, (SRC IP), a source port (SRC Port), a destination port (DST Port), a destination IP (DST IP), a destination ISP (DST Organization) and a destination country (DST Country) are represented. Although these maps are separately illustrated in FIGS. 9A to 9F, it is noted that the maps may be expressed in a single combined map.

Therefore, the user or the network manager can view the network attacks from the attack detection list S901. Also, the map may be designed to select any attack on the attack detection list, so that the manager can selectively view the images used for attack analysis, such as the traffic image S904 where the attack exists, the host analysis image 905, and the port analysis image S906, and can intuitively recognize the source and destination of the original traffic, the used protocol and the port number from the original traffic flow S903. Additionally, it is possible to check the time of occurrence of abnormal phenomenon based on the similarity between traffic images with the passage of time, thereby confirming the network attack list and image pattern detected at the time of occurrence of abnormal phenomenon in real time.

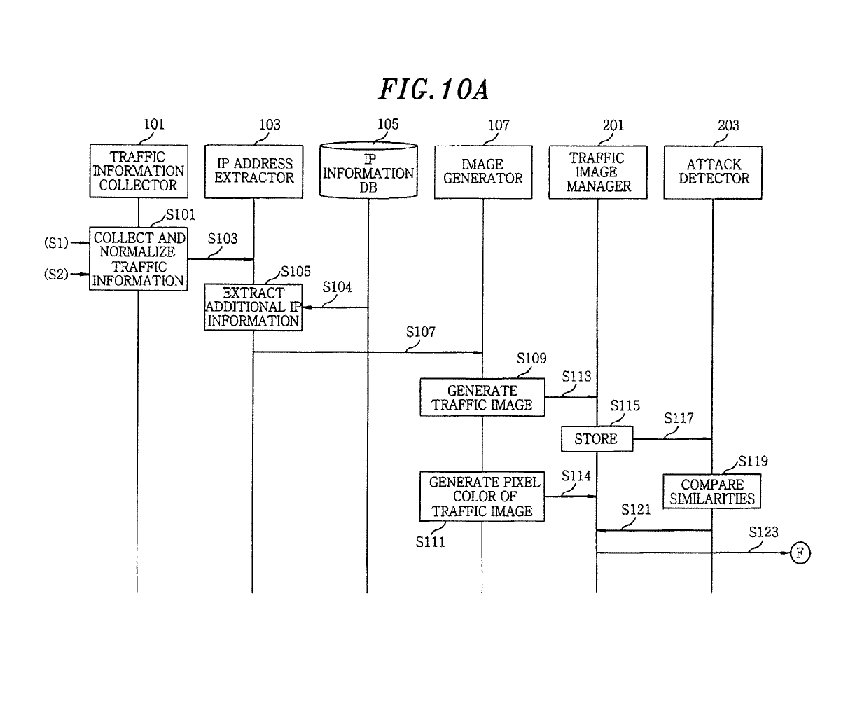

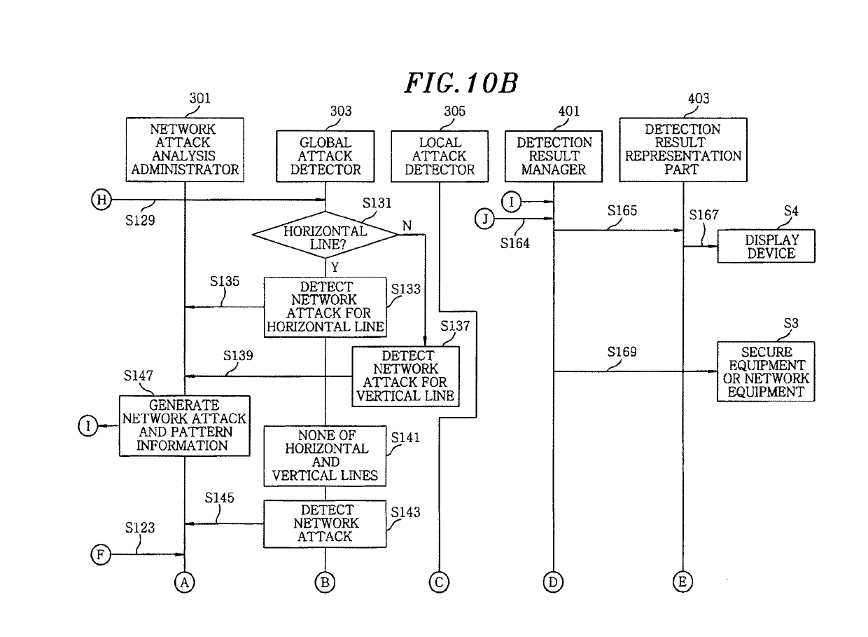

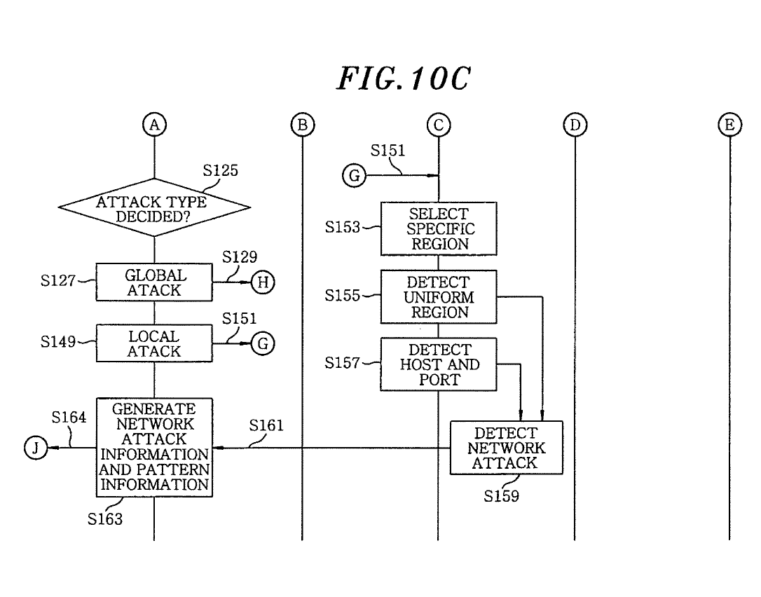

Hereinafter, a procedure of detecting network attack based on visual data analysis in accordance with the embodiment of the present invention having the configuration as above will be described with reference to FIG. 10.

FIGS. 10A, 10B and 10C illustrates a flow chart sequentially showing the method for detecting network attack based on visual data analysis in accordance with the embodiment of the present invention.

Referring to FIG. 10A, in step S101, the traffic information collector 101 collects and normalizes traffic information provided from the network equipment S1 or the traffic generation equipment S2. The normalized traffic information is then provided to the IP address extractor 103 in step S103.

In steps S104 and S105, the IP address extractor 103 searches the IP information DB 105 for IP information of the traffic information such as a source IP and a destination IP, source port, destination port, protocol, and statistics), and then, extracts additional (geographical) IP information including country, AS, company, ISP, latitude, longitude, and management domain to which the IP address belongs. The IP information and the geographical information are then provided to the image generator in step S107.

Thereafter, in the image generator 107, an N×N traffic image is generated using the IP information and the geographical information from the IP address extractor 103, in step S109. The N×N traffic image is then provided to the traffic image manager 201 in the network attack detector 200, in step S113.

In addition, in step S111, the image generator 107 may generates a traffic image in a graph form where a color of pixel represents a numerously-distributed port in traffics. The pixel color of traffic image may also be provided to the traffic image manager 201 in the network attack detector 200, in step S114.

The traffic image manager 201 in the network attack detector 200 stores the traffic image from the image generator 107 in step S115. Upon a request from the attack detector 203, the stored traffic image is provided to the attack detector 203, in step S117.

Subsequently, in step S119, the attack detector 203 compares similarity between the traffic image from the traffic image manager 201 and a previously generated traffic image. If the similarity difference exceeds a similarity threshold, it is decided that network attack has occurred, and the detection result for the network attack is provided to the traffic image manager 201, in step S121.

After that, in step S123, the traffic image manager 201 sends the detection result from the attack detector 203 along with the traffic image to the network attack analyzer 300 through a tab ‘F’.

In the network attack analyzer 300, the network attack analysis administrator 301 decides whether there is a global attack or a local attack in view of the detection result of the network attack, in step S125 (see FIG. 10C).

If the decision result in step S125 indicates the global attack in step S127, the network attack analysis administrator 301 provides the traffic image to the global attack detector 303 to make a request for network attack analysis through a tab ‘H’, in step S129.

Then, in the global attack detector 303, as shown in FIG. 10B, a line in the traffic image is detected using a line detection algorithm and it is determined whether the detected line is a horizontal line or a vertical line by considering the slope of the detected line, in step S131.

If the detected line is the horizontal line, which means that the traffic is being sent from a specific source IP to multiple destination IPs, the global attack detector 303 analyzes the traffic on the basis of the source IP to detect a kind of the network attack, in step S133, and provides the network attack analysis manager 301 with the analysis result, in step S135.

If, however, in step S131, the detected line is the vertical line, which means that multiple source IPs is sending traffic to a specific destination IP, the global attack detector 303 analyzes the traffic based on the destination IP in step S137 to detect a kind of the network attack. The analysis result for the network attack is provided to the network attack analysis manager 301, in step S139.

Meanwhile, if the decision result in step S131 is neither of a horizontal line nor a vertical line as in step S141, the global attack detector 303 detects network attack depending on the distribution of source and destination IPs in step S143. The analysis result for the network attack is then provided to the network attack analysis manager 301, in step S145.

Thereafter, in step S147, the network attack analysis administrator 301 generates network attack information and pattern information for the network attack based on the analysis results, and provides the network attack information and pattern information to the detection result manager 401 in the representation unit through a tab ‘I’.

On the other hand, if the decision result indicates the local attack as in step S149 (see FIG. 10C), the network attack analysis administrator 301 provides the traffic image to the local attack detector 305 to make a request for network attack analysis through a tab ‘G’, in step S151.

The local attack detector 305 selects a specific region in the traffic image in step S153. And then, the local attack detector 305 generates a host analysis image and a port analysis image for the selected specific region to detect a uniform region and spot region in step S155, and detects host and port with features from the traffic image based on the intensity of the traffic image, color analysis, edge detection, and so on in step S157.

Thereafter, the local attack detector 305 checks the traffic related to the host and port based on the detected uniform region and the spot region to identify a kind of the network attack in step S159. The analysis result is then provided to the network attack analysis administrator 301 in step S161.

In subsequence, the network attack analysis administrator 301 generates network attack information and pattern information of the network attack based on the analysis results in step S163. The network attack information and pattern information is then provided to the detection result representation unit 400 through a tab ‘J’, in step S164.

As shown in FIG. 10B, in the detection result representation unit 400, the detection result manager 401 then provides the network attack and pattern information to the detection result representation part 403 in step S165.

Then, the detection result representation part 403 discriminately constructs the network attack information and pattern information of the network attack in the form of a map for the network attack detection as shown in FIG. 9, and displays the map on a display device S4 so that the network manager can identify them, in step S167.

Also, in step S169, the detection result manager 401 generates and transmits, to other secure equipment or other network equipment S3, an alarm message notifying that network attack has occurred. The method for detecting network attack based on visual data analysis in accordance with the present invention can be written in computer program. Codes and code segments constituting the computer program can easily be deduced by a computer programmer in the art. Further, the computer program is stored in a computer-readable storage medium, and then read and executable by the computer, thereby implementing the method for detecting network attack based on the visual data analysis. Examples of the computer-readable storage medium include a magnetic storage medium, an optical storage medium and a carrier wave medium.

As described above, according to the present invention, traffic information is transformed into traffic images and then the traffic images is then processed using the visual data analysis technique to detect various attacks occurring in the network, thus solving the existing problems that a conventional abnormal detection model misjudges non-attacks as attacks and a conventional misuse detection model cannot perform detection on unknown attacks.

While the present invention has been described with respect to particular embodiments, it will be apparent to those skilled in the art that various changes and modifications may be made without departing from the scope of the present invention as defined in the following claims.

What is claimed is:

1. An apparatus for detecting a network attack, comprising:
a traffic image generator for generating a traffic image using traffic information and additional IP information extracted from the traffic information;
a network attack detector for comparing similarities between the traffic image and a previously generated traffic image based on a predetermined similarity threshold to detect the presence of the network attack;
a network attack analyzer for analyzing the traffic image at a time when the network attack is detected to detect network attack information and pattern information of the network attack; and
a representation unit for visualizing the network attack information and the pattern information of the network attack.

2. The apparatus of claim 1, wherein the traffic image generator includes:
a traffic information collector for collecting the traffic information;
an IP address extractor for extracting additional IP information for the traffic information, wherein the additional IP information includes a source IP, destination IP and statistics; and
an image generator for mapping destination and source information to vertical and horizontal axes, respectively, to thereby generate the traffic image, wherein a pixel in the traffic image represents a traffic flow from the source IP to the destination IP.

3. The apparatus of claim 2, wherein each of the source IP and destination IP includes country, autonomous system (AS), company, Internet service provider (ISP), latitude, longitude, and management domain, to which an IP address belongs.

4. The apparatus of claim 2, wherein the traffic image is generated in synchronized with a cycle T during which the traffic information is collected.

5. The apparatus of claim 2, wherein a color of the pixel represents the statistics of the traffic flow from the source IP to the destination IP.

6. The apparatus of claim 1, wherein the network attack detector includes:
an attack detector for comparing a similarity between the traffic image and the previously generated traffic image to decide the presence of the network attack if a similarity difference exceeds the predetermined similarity threshold; and
a traffic image manager for providing a detection result indicating the presence of the network attack to the network attack analyzer.

7. The apparatus of claim 6, wherein the similarity comparison is performed by a scene change detection technique using the change in pixel color or between discrete cosine transform (DCT) variables.

8. The apparatus of claim 3, wherein the network attack analyzer includes:
a network attack analysis administrator for making a request for analysis of the network attack depending on whether the network attack is a global attack or a local attack, and generating the network attack information and the pattern information of the network attack based on a network attack analysis result received in response to the request;
a global attack detector for analyzing the traffic between the source IP and the destination IP in the traffic image, and the distribution of the source and destination IPs in the traffic image to identify a kind of the network attack; and
a local attack detector for analyzing traffic volume for each host and port in the traffic image to identify a kind of the network attack.

9. The apparatus of claim 8, wherein the image processing technique is one of an image segmentation technique, a connected component labeling technique, and an edge detection technique.

10. The apparatus of claim 1, wherein the representation unit includes:
a result representation part for constructing a map of attack detection results by combining the network attack information and the pattern information of the network attack.

11. The apparatus of claim 10, wherein the map of attack detection results is comprised of network attack detection list, similarity between the traffic images, an original traffic flow, a traffic image, an image for host analysis and an image for port analysis.

12. A method for detecting a network attack, comprising:
generating a traffic image using traffic information and additional IP information extracted from the traffic information;
comparing similarities between the traffic image and a previously generated traffic image based on a predetermined similarity threshold to detect the presence of the network attack;
analyzing the traffic image to detect network attack information and pattern information of the network attack; and
visualizing the network attack information and the pattern information of the network attack.

13. The method of claim 12, wherein said collecting traffic information includes:
collecting the traffic information;
extracting the additional IP information for the traffic information, wherein the additional IP information includes source IP, destination IP and statistics; and
mapping destination and source information to vertical and horizontal axes, respectively, to thereby generate the traffic image, wherein a pixel in the traffic image represents a traffic flow from the source IP to the destination IP.

14. The method of claim 13, wherein each of the source IP and destination IP includes country, autonomous system (AS), company, internet service provider (ISP), latitude, longitude, and management domain, to which an IP address belongs.

15. The apparatus of claim 10, wherein the traffic image is generated in synchronized with a cycle T during which the traffic information is collected.

16. The method of claim 13, wherein a color of the pixel represents the statistics of the traffic flow from the source IP to the destination IP.

17. The method of claim 12, wherein said analyzing the traffic image includes:
comparing a similarity between the traffic image and the previously generated traffic image;
if a similarity difference exceeds the predetermined similarity threshold, deciding the presence of the network attack; and
if there exists the network attack, generating a detection result indicating the presence of the network attack.

18. The method of claim 16, wherein the similarity comparison is performed by a scene change detection technique using the change in pixel color or between discrete cosine transform (DCT) variables.

19. The method of claim 12, further comprising:
determining whether the network attack is a global attack or a local attack in accordance with the detection result of the presence of the network attack,
wherein said analyzing the traffic image includes:
if the network attack is a local attack, analyzing the traffic between the source IP and the destination IP in the traffic image, and the distribution of the source and destination IPs in the traffic image to identify a kind of the network attack; and
if the network attack is a global attack, analyzing traffic volume for each host and port in the traffic image to identify a kind of the network attack.

20. The method of claim 12, wherein said visualizing the network attack information and pattern information includes:
constructing a map of attack detection results, which is obtained by combining the network attack information and the pattern information of the network attack, and displaying the list of attack detection results on a display device.
